(19) United States
(12) Patent Application Publication
(10) Pub. No.: US 2008/0244415 A1
(43) Pub. Date: Oct. 2, 2008

(54) Internet Mail Client System For Mobile Devices Using Remote Computer Systems and Method Thereof

(75) Inventor: Jae Bum Shim, Seoul (KR)

Correspondence Address: STEPTOE & JOHNSON LLP, 1330 CONNECTICUT AVENUE, N.W., WASHINGTON, DC, 20036, US

(73) Assignee: Logicplant, Seocho-ku (KR)

(21) Appl. No.: 12/093,919

(22) PCT Filed: Nov. 16, 2006
(86) PCT No.: PCT/KR2006/004833

§ 371 Date: May 16, 2008

(30) Foreign Application Priority Data
Nov. 16, 2005 (KR) 10-2005-0109783

(51) Int. Cl. G06F 15/16

(52) U.S. Cl. 715/740

(57) ABSTRACT

The present invention relates to an Internet mail client system for a mobile device employing a remote computer and a control method thereof. The Internet mail client system for a mobile device according to the present invention includes a remote computer accessible to a mail server, a mobile device provided with a user interface for controlling an operation of the remote computer, and a control server for controlling an operation corresponding to a mail processing function item, which is requested by the mobile device through the user interface, to be executed in the remote computer, and notifying the mobile device of an operating status of the remote computer. Furthermore, when the remote computer is not available, the control server can perform some of functions of the remote computer. According to the present invention, a mail task can be performed to the same extent that the task is directly performed in a personal computer by using a mobile device and a remote computer at a predetermined place.

### TECHNICAL FIELD

The present invention relates, in general, to an Internet mail client system for a mobile device and a control method thereof and, more particularly, to an Internet mail client system for a mobile device and a control method thereof, in which a mail task is performed to the same extent that the task is directly performed in a general computer by using a mobile device and a remote computer at a predetermined place.

### BACKGROUND ART

As a mobile device, such as a mobile phone, is widely used and wireless Internet becomes active, the mobile device has secured its position as an information terminal that is available at any place.

However, the mobile device is absolutely short of information storage space compared with an information terminal, such as the existing personal computer, making it difficult to be used as a main information terminal. Accordingly, a user stores most of information in a personal computer, temporarily performs a task using a mobile device while moving, and then synchronizing the personal computer and the information.

A similar method as above is also used in an Internet mail. That is, a user checks his emails in his mobile device, makes a simple reply, if needed, and then synchronizes information between a personal computer, that is, a main information device, and the mobile device.

A mobile device is also short of functions compared with a personal computer. It has a small screen, a small input device, and a limited information representation format. Of them, the reason why the information representation format is limited is that the device is short of the performance and capability, and does not have application programs capable of representing corresponding information or has limited application programs. This serves as a limiting factor in using Internet mail in a mobile device.

For example, when a user views a document file attached to a file, in the case where a mail client mounted in a corresponding mobile device cannot analyze a corresponding document file and display it on the screen, there is no method of viewing the contents of the document, making impossible the mail process.

Today, some mail clients for mobile devices are equipped with a viewer for some document formats. However, the mail clients are problematic in that they do not have a complete function comparable to that of a personal computer and have limited kinds of document formats that can be processed.

There is also a problem in information synchronization between a mobile device and a personal computer. In general, when information is changed as tasks are performed at separate places, information synchronization between two devices is subsequently performed. At this time, mail sent from the mobile device is transferred to a mail client of that personal computer that serves as a main information terminal.

However, the mobile device is short of information storage space as described above. Thus, the mobile device cannot store mail contents stored in the mail client of the personal computer. Accordingly, information synchronization is mainly performed in a direction in which information is integrated into the personal computer, that is, the main information terminal, and only a small amount of information, such as an address directory, is stored in the mobile device.

There is a limit in the processing of mail in the mobile device due to such asymmetric synchronization. The limit means that mail stored in the personal computer cannot be seen or additionally processed. When mails are processed, previous mails are frequently seen. Thus, such limit has a serious influence on the processing of new mails.

As a similar matter, the fact that general documents stored in the personal computer cannot be seen also serves as a similar limiting factor in mail processing. The processing of mails is a kind of information process. Information processing indispensably requires reference on related information. However, this is impossible in general mobile devices.

Accordingly, for the purpose of a preferred mobile mail processing task, a mobile mail client system must additionally include the following functions other than the functions of a general mail client. A variety of formats used in representing information in a personal computer must be processed at the same level as the personal computer, and corresponding information must be displayed on the screen of a mobile device. It is also required that information stored in a main information terminal, such as a personal computer, be viewed and used anytime. In addition, users in general manage two kinds of personal and business information separately, and have additional personal computers for them. It is more preferred that a method of allowing several main information terminal environments to be easily used in one mobile mail client be provided.

### DISCLOSURE OF INVENTION

### Technical Problem

Accordingly, it is an object of the present invention to provide an Internet mail client system and a control method thereof, in which a mail task is performed to the same extent that the task is directly performed in a general computer by using a mobile device and a remote computer at a predetermined place.

### Technical Solution

To achieve the above object, an Internet mail client system for a mobile device according to the present invention includes a remote computer accessible to a mail server, a mobile device provided with a user interface for controlling an operation of the remote computer, and a control server for controlling an operation corresponding to a mail processing function item, which is requested by the mobile device through the user interface, to be executed in the remote computer, and notifying the mobile device of an operating status of the remote computer.

The remote computer may include a personal computer that is connected to the control server and the mail server over an Internet. At this time, the remote computer may include a mail client for performing a mail processing operation through the mail server, and an agent for controlling an operation of the mail client under the control of the control server. Further, the mobile device may include a mobile communication terminal that is connected to the control server over a mobile communication network and an Internet.

The control server may include a management database for storing and managing information for user certification and a user's mail environment profile through the mobile device, and a control unit for controlling an operation of the management database.

The user interface may include at least one of menu items, such as a mail folder list view employing the remote computer, a mail list view within a folder, a mail contents view, a mail view through the control server, a mail view, mail write and send after accessing the mail server, mail reply write and send, attachment of a file stored in the remote computer or the mobile device to a mail, receive file stored in the remote computer, dialing employing an address directory of the remote computer, and send and synchronization of a mail, which is sent without accessing the remote computer, to the remote computer. In the case where the remote computer is not available, the mobile device can receive and send a mail through one of the control server and the mail server.

Meanwhile, according to the present invention, there is provided a method of controlling an Internet mail client system for a mobile device, including a remote computer, a mobile device, and a control server that are connected over a network and can communicate each other, the method including the steps of allowing the mobile device to inquire a user interface for controlling an operation of the remote computer and select a mail processing function item, allowing the control server to control the remote computer so that an operation corresponding to the selected mail processing function item is performed, allowing the remote computer to gain access to a mail server and notify the control server of a result of performing the operation corresponding to the selected mail processing function item, and allowing the control server to receive the result of performing the operation of the remote computer and notify the mobile device of the result. Preferably, the method may further include the step of allowing the mobile device to request authentication from the control server and receive authentication for the request from the control server.

Furthermore, the method of controlling the Internet mail client system employing the remote computer according to the present invention further includes the step of, when the remote computer is not available, allowing the mobile device to directly gain access to the mail server and receive a mail, or allowing the mobile device to gain access to the control server and receive a mail, which is received and stored by the control server that gains access to the mail server.

Furthermore, the method of controlling the Internet mail client system employing the remote computer according to the present invention further includes the step of, when a new mail is arrived, allowing the remote computer to periodically access the mail server, transfer a program that is performed in the mobile device by using a mobile communication network information transfer function, such as SMS, as a background, and display new mail information on the user interface of the mobile device. At this time, when the remote computer is not available, the control server can serve as the remote computer.

Furthermore, the method of controlling the Internet mail client system employing the remote computer according to the present invention further includes the step of, when the remote computer is not available, allowing a mail written in the mobile device to be directly sent by allowing the mobile device to directly access the mail server without via the remote computer or through the relay of the control server.

Furthermore, the method of controlling the Internet mail client system employing the remote computer according to the present invention further includes the step of allowing the mail directly sent by the mobile device without via the remote computer to be transmitted to the remote computer and then synchronized, when the remote computer becomes available.

### ADVANTAGEOUS EFFECTS

In accordance with the present invention, since a remote computer is controlled through a mobile device at a predetermined place, a mail task can be performed to the same extent that the task is directly performed in a personal computer. Accordingly, according to the present invention, all formats of information, which can be represented in a remote computer, can be viewed properly on the screen, and a stronger mail processing function of performing a task using all information stored in the remote computer can be provided, compared with a conventional service in which a new mail is opened using a limited format and a simple response for the main is written and sent.

Further, even when a remote computer is not available, functions of a conventional service level can be used. At this time, information, which is generated or transferred from a mobile device, can be synchronized to the remote computer later on.

Furthermore, an Internet mail client system for a mobile device according to the present invention can provide a method in which a variety of information formats are processed at the same level as that of a personal computer and are displayed on the screen of a mobile device, and information stored in a main information terminal can be viewed anytime and easily used in several main information terminal environments, other than a general mail client function, such as new main confirm, mail view, and mail send. Accordingly, a stronger mail processing environment can be constructed.

### BRIEF DESCRIPTION OF THE DRAWINGS

FIG. 1 is a view illustrating the configuration of an Internet mail client system for a mobile device according to an embodiment of the present invention;

FIGS. 2 to 4 are message sequence charts illustrating a method of driving the Internet mail client system for a mobile device according to an embodiment of the present invention; and

FIGS. 5 to 7 are views to which reference is made in order to illustrate a method of driving the Internet mail client system for a mobile device according to an embodiment of the present invention along with a user interface provided in the mobile device.

### BEST MODE FOR CARRYING OUT THE INVENTION

Hereinafter, the present invention will be described in detail with reference to the drawings.

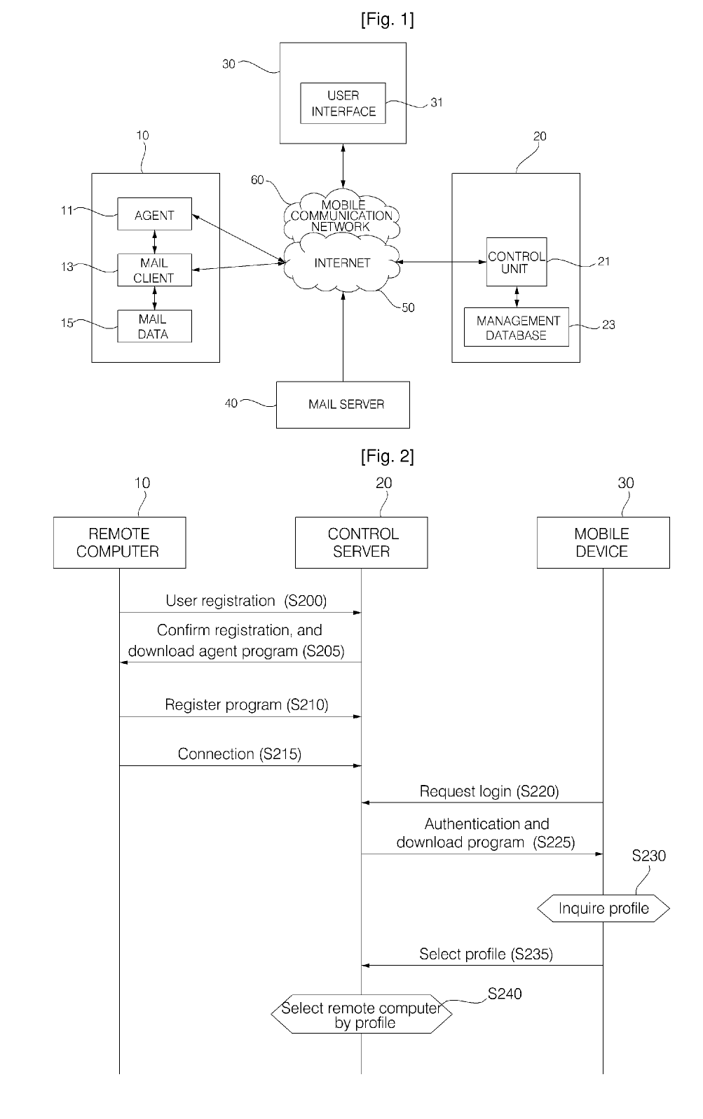

FIG. 1 is a view illustrating the configuration of an Internet mail client system for a mobile device according to an embodiment of the present invention.

Referring to FIG. 1, a control server 20 is installed at a company that provides an Internet mail service for a mobile device. The control server 20 is connected to a remote computer 10 over an Internet 50. The control server 20 is connected to a user's mobile device 30 over the Internet 50 and a mobile communication network 60.

The remote computer 10 includes an agent 11, a mail client 13, and mail data 15.

The remote computer 10 may include a user's personal computer accessible to the Internet or the like. In the remote computer 10, the mail client 13 is a general mail client, and the agent 11 controls the mail client 13. Further, the mail data 15 stores mails, etc., which are transmitted and received through the mail client 13. The mobile device 30 is equipped with a user interface 31, and can communicate with the control server 20 over the Internet 50 and the mobile communication network 60. The mobile device 30 may include a user's mobile phone or the like.

The control server 20 includes a control unit 21 and a management database 23. The management database 23 stores information about user certification, and each user's databased mail environment profile. Furthermore, in the case where the remote computer 10 is not available, a mail received from the mail server 40 can be temporarily stored in the control server 20 before it is transmitted to the mobile device 30. The mail temporarily stored in the control server 20 can be transmitted to the remote computer 10 for synchronization.

Furthermore, the control unit 21 periodically gains access to the mail server 40. If a new mail is arrived, the control unit 21 informs the mobile device 30 of the fact by using a mobile communication network information transfer function, such as Short Message Service (SMS). It is preferred that this function be operated only when the remote computer 10 is not available.

The agent 11 of the remote computer 10 controls the mail client 13 to be applicable to the mobile device 30. The agent 11 opens other information stored in the remote computer 10, and performs a mail-related operation instruction received from the control server 20 through the user interface 31 of the mobile device 30. At this time, a method in which the agent 11 controls the mail client 13 may differ depending on the type of the mail client 13. A main control method includes OLE automation, Windows message hooking, keyboard and mouse message generation, and so on. A proper combination of the methods can be used.

Furthermore, the agent 11 periodically accesses the mail server 40 or checks the status of the mail client 13. If a new mail is arrived, the agent 11 can inform the mobile device 30 of the fact by using a mobile communication network information transfer function, such as SMS. The mail client 13 gains access to the mail server 40 through the Internet 50 for a mail-related task under the control of the agent 11.

The mobile device 30 shows the user interface 31 to a user. If the user selects a desired operation, the mobile device 30 transfers the operation to the remote computer 10 through the control server 20 so that a mail operation can be performed.

Furthermore, the mobile device 30 can receive files stored in the remote computer 10 or can transmit files stored in the mobile device 30. In the case where the mobile device 30 is a device capable of providing a dialing function, such as a mobile phone, the mobile device 30 can provide a dialing function by using an address directory stored in the remote computer 10.

In the event that the remote computer 10 is not available, a new mail can be received or transmitted through the control server 20 or by directly accessing the mail server 40. The mobile device 30 can also display new mail information, informed from the remote computer 10 or the control server 20, on the user interface 31.

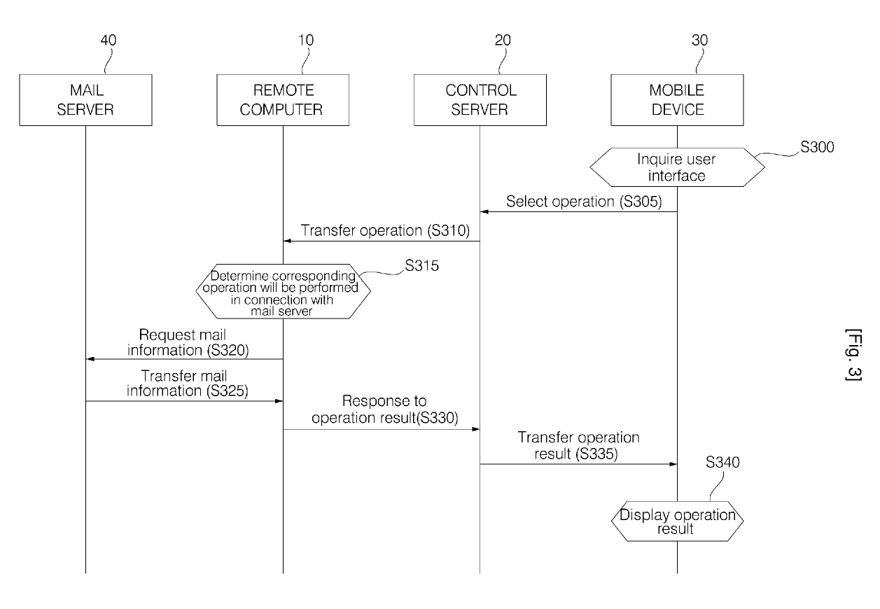

FIGS. 2 to 4 are message sequence charts illustrating a method of driving the Internet mail client system for a mobile device according to an embodiment of the present invention.

FIG. 2 is a message sequence chart shown to schematically illustrate items related to initialization, of the method of operating the Internet mail client system for a mobile device employing a remote computer according to an embodiment of the present invention.

Referring to FIG. 2, user registration for employing service is requested from the control server 20 through the remote computer 10 in step S200. If registration is completed, a program for confirming registration and driving the agent 11 is downloaded from the remote computer 10 in step S205. Though not shown in the drawing, a program for providing the user interface 31 is downloaded onto the mobile device 30.

The remote computer 10 executes the downloaded program to drive the agent 11. The mobile device 30 gains access to the remote computer 10, and registers environment information for performing a mail-related task with the control server 20 as a profile in step S210. The agent 11 of the remote computer 10 always keeps access to the control server 20 so that the mobile device 30 can gain access to the remote computer 10 through the control server 20 anytime in step S215.

Thereafter, the mobile device 30 requests login for controlling the mail operation of the remote computer 10 in step S220. The control server 20 performs a certification procedure for the login, and controls a registered profile to be downloaded onto a corresponding mobile device 30 in step S225. The mobile device 30 inquires the downloaded profile in step S230. The mobile device 30 then selects a desired thing, and notifies the control server 20 of the result in step S235. The control server 20 determines which remote computer 10 will be selected through the selected profile in step S240, and transfers a mail task-related operation received from the mobile device 30.

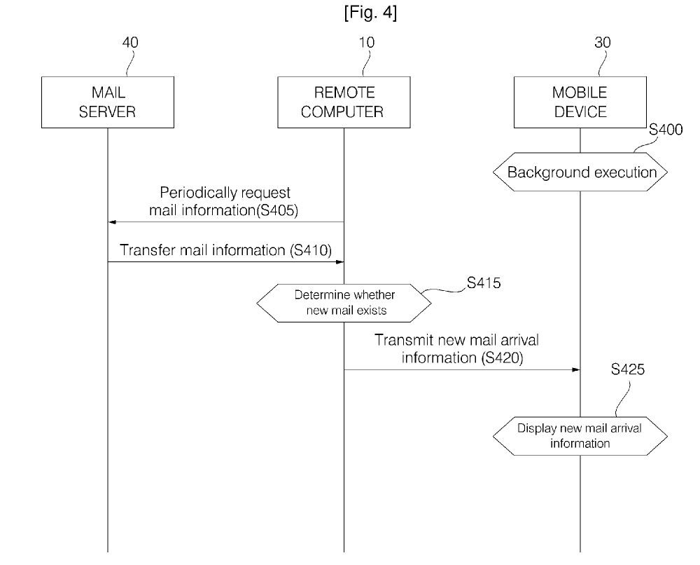

FIG. 3 is a message sequence chart shown to schematically illustrate items related to a mail-related task, of the method of operating the Internet mail client system for a mobile device employing a remote computer according to an embodiment of the present invention.

Referring to FIG. 3, the mobile device 30 inquires the user interface 31 for the mail-related task in step S300, selects a necessary function, and requests a corresponding operation from the control server 20 in step S305.

The control server 20 transfers the operation requested by the mobile device 30 to the remote computer 10 in step S310. The remote computer 10 performs the requested operation. In this case, the remote computer 10 determines whether a corresponding operation will be performed in connection with the mail server 40 in step S315, and connects the operation to the mail server 40, if appropriate. The remote computer 10 requests mail information from the mail server 40 in step S320, and receives mail information processed by the mail server 40 in step S325. The remote computer 10 transfers the result of performing the requested operation to the control server 20 in step S330. The control server 20 transfers the received result to the mobile device 30 in step S335. The mobile device 30 displays the received result on the screen through the user interface 31 in step S340.

FIG. 4 is a message sequence chart shown to schematically illustrate items related to new mail notification, of the method of operating the Internet mail client system for a mobile device employing a remote computer according to an embodiment of the present invention.

Referring to FIG. 4, the mobile device 30 executes a program for receiving new mail notification as a background in step S400 so that a mail can be notified anytime. The remote computer 10, or the control server 20 when the remote computer 10 is not available periodically gains access to the mail server 40, and requests mail information in step S405.

If mail information is received from the mail server 40 in step S410, the remote computer 10 determines whether a new mail exists in step S415, and transmits new mail arrival information to the mobile device 30 in step S420. The mobile device 30 displays the new mail arrival information on the user interface 31 in step S425. At this time, the remote computer 10 can indirectly extract new mail arrival information by controlling the mail client 13 instead of directly accessing the mail server 40.

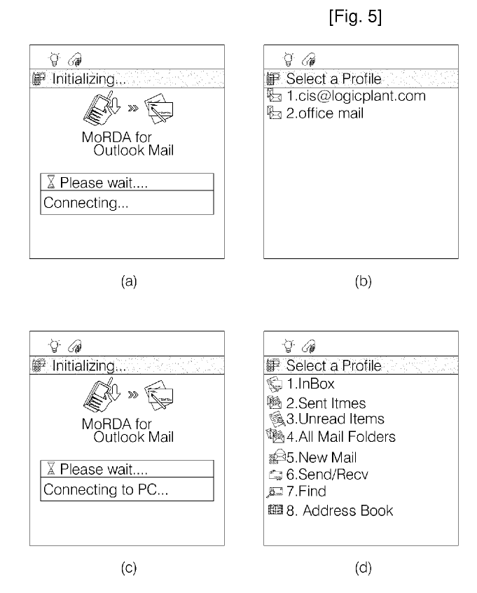

FIGS. 5 to 7 are views to which reference is made in order to illustrate the method of driving the Internet mail client system for a mobile device according to an embodiment of the present invention along with the user interface provided in the mobile device.

FIG. 5 is a view shown to illustrate a situation in which a user accesses the control server 20 by using the mobile device 30 in order to employ the mail client.

A user gains access to the control server 20 by pressing a key provided in the mobile device 30 as illustrated in FIG. 5(a). When the mobile device 30 is a mobile phone, the control server 20 can transfer a corresponding user's profile to the mobile device 30 by using a mobile phone number or through a certification procedure, such as receiving a password. When the number of the profile is one, the mobile device 30 is connected to the remote computer 10 indicated by a corresponding profile as illustrated in FIG. 5(c), and when the number of the profile is several, a screen for selecting profiles is displayed and one of the profiles is selected as illustrated in FIG. 5(b).

If the mobile device 30 is successfully connected to the remote computer 10 indicated by the profile, a main menu, that is, an initial user interface 31 is displayed as illustrated in FIG. 5(d). The main menu includes the names of main mail folders, and other function items.

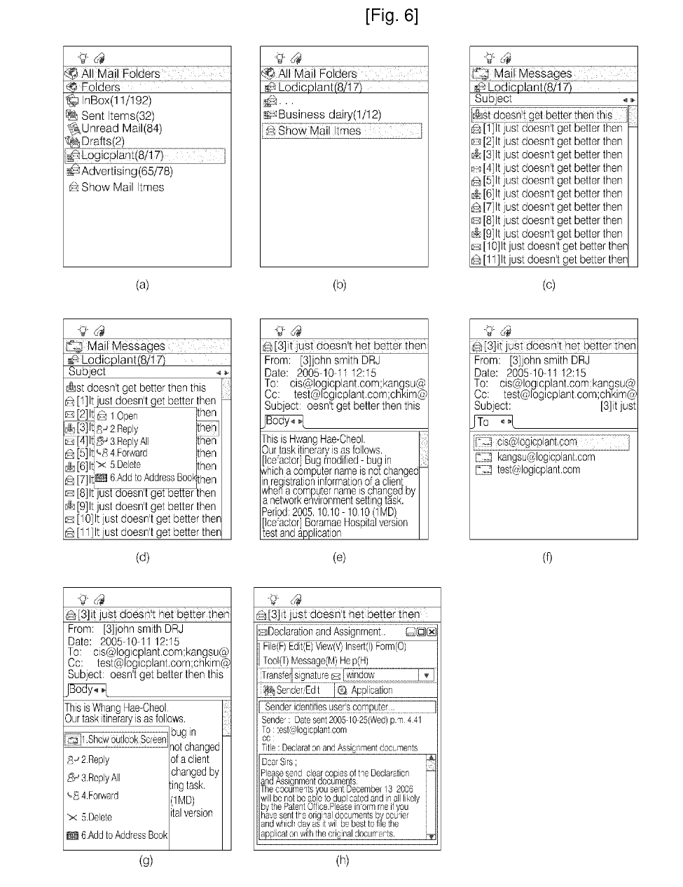

FIG. 6 is a view shown to illustrate a case where after a specific mail folder is selected, mails within the folder are opened.

As illustrated in FIG. 6, a user can confirm newly arrived mails by selecting a received mailbox, and can view the existing mails by selecting a specific mail folder.

In FIG. 6, (a) shows a process of selecting a folder list, (b) shows a process of selecting a mail list view from a selected folder, and (c) shows that a selected mail list is displayed. Further, (d) shows a process of selecting mail view, and (e) shows that mail contents are displayed.

In the process of selecting a folder or a mail as described above, menu items of a list form, menu items of a pop-up form, and so on are used. If a folder or a mail is selected, the mobile device 30 transfers information about a corresponding operation to the control server 20. The remote computer 10 receives the information, performs an actual operation, and then transmits the processing result to the mobile device 30 through the control server 20. The result is displayed on the user interface 31 of the mobile device 30 such that a next operation can be performed.

Mail contents can be received and displayed in a text format, or the mail client can receive and display a captured image displayed on the screen. The captured image can be seen without being changed in a format displayed on the screen of the remote computer.

In FIG. 6, (f) shows a process of selecting a mail recipient list, (g) shows an example in which direct view through a computer screen is selected, and (h) shows a screen on which direct view is executed on the computer screen. This is true of a case where an attached file is viewed. Accordingly, various formats of information can be seen and processed to the same level as that displayed on the screen of the personal computer.

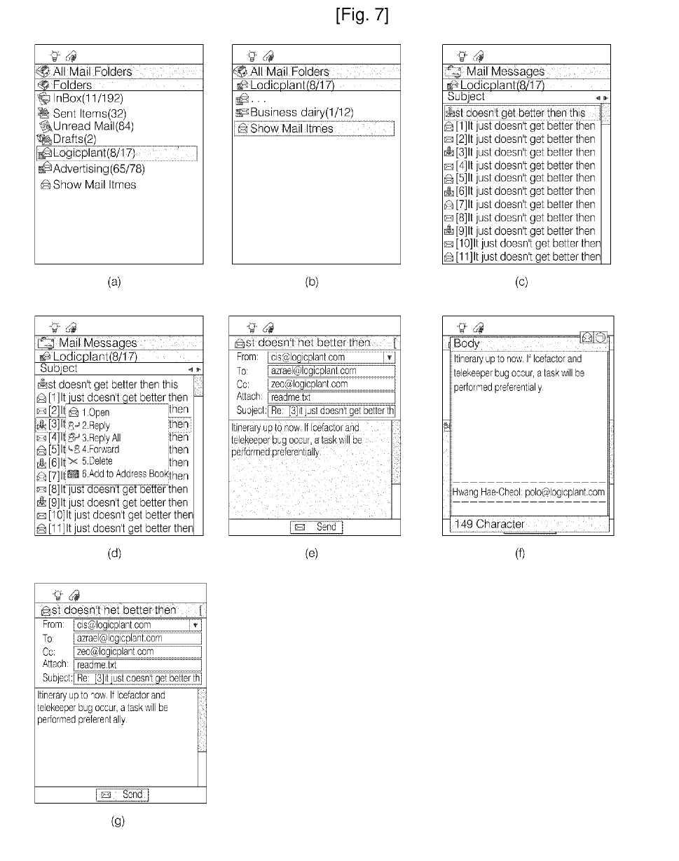

FIG. 7 is a view shown to illustrate a case where after a specific mail is viewed, a reply is written and sent. A reply can be directly written in the mobile device 30, as shown in FIG. 7, or can be written in such a manner that the screen of the mail client 13 of the remote computer 10 is controlled remotely. When the remote computer 10 is not available, only a method of directly writing a reply is possible.

In FIG. 7, (a) shows a process of selecting a folder list, (b) shows a process of selecting mail list view from a selected folder, and (c) shows that a selected mail list is displayed. Further, in FIG. 7, (d) shows a process of selecting to make a reply, (e) shows a case where a mail main text is selected, and (f) shows a process of editing a selected mail main text.

If a user presses a send button as in (g) after the mail main text is edited through the above process, the contents of the reply are transferred to the remote computer 10 through the control server 20. The agent 11 of the remote computer 10 controls the mail client 13 to send a corresponding mail. In the case where a method of remotely controlling the screen of the mail client 13 is used, contents are not transferred separately, but only a transmission instruction is transmitted to the remote computer 10. At this time, a file stored in the remote computer 10 can be specified as an attached file.

Through the above process, a mail task can be performed to the same extent that the task is directly performed in a personal computer by using a mobile device at a pre-determined place.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

In accordance with the Internet mail client system for a mobile device and a control method thereof, a mail task can be performed to the same extent that the task is directly performed in a personal computer by using a mobile device and a remote computer at a predetermined place.

1.-20. (canceled)

21. An Internet mail client system for a mobile device, comprising:
a remote computer accessible to a mail server;
a mobile device provided with a user interface for controlling an operation of the remote computer; and
a control server connected to the remote computer and the mobile device so as to be able to communicate with the remote computer and the mobile device,
wherein, if the control server transmits a mail processing operation, which is requested through the user interface by the mobile device, to the remote computer, the remote computer performs the mail processing operation by accessing the mail server, and transmits the result of the performing of the mail processing operation to the control server, and the control server receives the result of the performing of the mail processing operation from the remote computer and then notifies the mobile device of the result of the performing of the mail processing operation.

22. The Internet mail client system of claim 21, wherein the remote computer includes a personal computer that is connected to the control server and the mail server over an Internet.

23. The Internet mail client system of claim 22, wherein the remote computer comprises:
a mail client for performing a mail processing operation through the mail server; and
an agent for controlling an operation of the mail client under the control of the control server.

24. The Internet mail client system of claim 21, wherein the mobile device includes a mobile communication terminal that is connected to the control server over a mobile communication network and an Internet.

25. The Internet mail client system of claim 21, wherein the control server comprises:
a management database for storing and managing information for user certification and a user's mail environment profile through the mobile device; and
a control unit for controlling an operation of the management database.

26. The Internet mail client system of claim 21, wherein the user interface includes at least one of menu items, such as a mail folder list view employing the remote computer, a mail list view within a folder, a mail contents view, a mail view through the control server, a mail view, mail write and send after accessing the mail server, mail reply write and send, attachment of a file stored in the remote computer or the mobile device to a mail, receive file stored in the remote computer, dialing employing an address directory of the remote computer, and send and synchronization of a mail, which is sent without accessing the remote computer, to the remote computer.

27. The Internet mail client system of claim 21, wherein, if where the remote computer is not available, the mobile device can receive and send a mail through the control server.

28. The Internet mail client system of claim 27, wherein:
in the case where the remote computer is not available, the control server accesses the mail server, receives a mail from the mail server, and temporarily stores the received mail, and
the mobile device receives the mail temporarily stored in the control server.

29. The Internet mail client system of claim 27, wherein the mail received and sent by the mobile device in a state where the remote computer is not available is transferred from the mobile device to the remote computer and is then synchronized, when the remote computer becomes available.

30. The Internet mail client system of claim 27, wherein if new mail information is received from the mail server, the control server sends the new mail information to the mobile device in order to notify the mobile device of the new mail information.

31. The Internet mail client system of claim 21, wherein if new mail information is received from the mail server, the remote computer sends the new mail information to the mobile device in order to notify the mobile device of the new mail information.

32. The Internet mail client system of claim 21, wherein the remote computer transmits a file stored in the remote computer to the mobile device through a mobile communication network and the Internet in order to refer to information, and receives a file stored in the mobile device through a mobile communication network and the Internet in order to synchronize information.

33. The Internet mail client system of claim 21, wherein when the mobile device can make a phone call by receiving a telephone number in an address directory stored in the remote computer.

34. A method of controlling an Internet mail client system for a mobile device, including a remote computer, a mobile device, and a control server that are connected over a network and can communicate each other, the method comprising:
allowing the mobile device to issue a request for a mail processing operation through a user interface for controlling an operation of the remote computer;
allowing the control server to transmit the requested mail processing operation to the remote computer;
allowing the remote computer to access to the mail server, to perform the requested mail processing operation, and to notify the control server of the result of the performing of the requested mail processing operation; and
allowing the control server to receive the result of the performing of the requested mail processing operation from the remote computer and to notify the mobile device of the result of the performing of the requested mail processing operation.

35. The method of claim 34, further comprising the step of allowing the mobile device to request authentication from the control server and receive authentication for the request from the control server.

36. The method of claim 34, further comprising the step of allowing the mobile device to request a user's mail environment profile from the control server and select one of profiles received as a result of the request.

37. The method of claim 34, wherein the remote computer includes a personal computer of an information user who is accessible to an Internet.

38. The method of claim 34, wherein the mobile device includes a mobile communication terminal of a user who is accessible to a mobile communication network.

39. The method of claim 34, wherein the user interface includes at least one of menu items, such as a mail folder list view employing the remote computer, a mail list view within a folder, a mail contents view, a mail view through the control server, a mail view, mail write and send after accessing the mail server, mail reply write and send, attachment of a file stored in the remote computer or the mobile device to a mail, receive file stored in the remote computer, dialing employing an address directory of the remote computer, and send and synchronization of a mail, which is sent without accessing the remote computer, to the remote computer.
